(19) United States
(12) Patent Application Publication
(10) Pub. No.: US 2010/0025177 A1
(43) Pub. Date: Feb. 4, 2010

(54) FLUID COUPLING DEVICE

(75) Inventors: Makoto Fukushima, Kariya-shi (JP); Tadayoshi Sato, Chita-gun (JP); Ryuta Miura, Nagoya-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 12/505,614

(22) Filed: Jul. 20, 2009

(30) Foreign Application Priority Data
Jul. 29, 2008 (JP) 2008-195150

(51) Int. Cl. F16D 31/00

(52) U.S. Cl. 192/58.68

(57) ABSTRACT

A fluid coupling device, includes a driving rotor, a driven rotor including an operation space, a valve unit supplying fluid stored in a storage space to the operation space and stopping supplying the fluid in accordance with a change in air temperature, and a pump portion for returning the fluid from the operation space to the storage space. A valve member of the valve unit is movable between a closed position and an open position, and includes an intermediate flow passage for keeping a predetermined amount of the fluid in the storage space and supplying the rest of the fluid to the opening when the valve member is in a predetermined position between the closed position and the open position.

### CROSS REFERENCE TO RELATED APPLICATIONS

This application is based on and claims priority under 35 U.S.C. §119 to Japanese Patent Application 2008-195150, filed on Jul. 29, 2008, the entire content of which is incorporated herein by reference.

### FIELD OF THE INVENTION

The present invention relates to a fluid coupling device.

### BACKGROUND

A fluid coupling device is disclosed, for example, in JP04-54318A (hereinafter referred to as Reference 1) and JP07-103259A (hereinafter referred to as Reference 2).

A fluid coupling device disclosed in the Reference 1 (the embodiment and FIGS. 1 to 3) includes a driving disc (corresponding to a driving rotor of the present invention) driven by a driving force and a sealed casing (corresponding to a driven rotor of the present invention) for allowing the driving disc to be accommodated in a torque transmission chamber. Further, the fluid coupling device includes a valve member for opening and closing an outflow adjusting hole provided on a wall of an oil sump. Still further, the fluid coupling device includes a temperature sensing portion and a rod. The temperature sensing portion is constituted by a bimetal and is deformed by temperature change, and the deformation is transmitted to the valve member via the rod. Also, labyrinth structures are provided on the driving disc and the torque transmission chamber so as to face each other and radially engage with each other.

Due to the above-described structure, the valve member operates as the temperature changes, and then oil in the oil sump is supplied to the torque transmission chamber. The driving disc and the sealed casing are unitarily rotated by a function of the oil in the labyrinth structures, and thus torque is transmitted.

A fluid coupling device disclosed in the Reference 2 (paragraphs 0007 to 0020) includes a rotor (corresponding to the driving rotor of the present invention) rotated by a driving force, an operation chamber, and a housing (corresponding to the driven rotor of the present invention) for allowing the rotor to be accommodated in the operation chamber. Further, the fluid coupling device includes a valve that is provided on a wall of a storage chamber provided in the housing, and opens and closes flow holes. Still further, the fluid coupling device includes a bimetal causing the valve to operate as temperature changes. The fluid coupling device also includes a labyrinth structure provided between the rotor and an interior of the housing.

The storage chamber includes a first storage chamber and a second storage chamber. The flow holes are provided on a wall of the first storage chamber and a wall of the second storage chamber respectively. The two flow holes are positioned so that, when the valve operates in an open direction as the temperature rises, the flow hole provided on the wall of the second storage chamber is opened first, and after that, the flow hole provided on the wall of the first storage chamber is opened.

Due to the above-described structure, when the temperature starts rising, a viscous fluid is supplied to the operation chamber via the flow hole provided on the wall of the second storage chamber. Thus, rotation is transmitted at an intermediate speed (in an MID state) by a function of the viscous fluid in the labyrinth structure. When the temperature further rises, the rotation is transmitted in an ON state. That is, a state where the transmission of the rotation is blocked, the state where the rotation is fully transmitted, and the state where the rotation at the intermediate speed is transmitted are established.

According to the References 1 and 2, the fluid coupling device includes a fan in an outer periphery of the driven rotor, and is assumed to be located, for example, behind a radiator installed in an engine room of a vehicle. According to the fluid coupling devices, the fan is not actuated when the temperature of the air passing through the radiator is low, and is actuated when the air temperature rises, thereby realizing a more efficient cooling effect.

Considering that the temperature of the radiator gradually rises as the temperature of an engine coolant rises, a need exists for the fluid coupling device which provides the state where the transmission of the driving force is blocked, the state where the driving force is fully transmitted, and a so-called half clutch state between the aforementioned two states, as is disclosed in Reference 2.

However, the fluid coupling device disclosed in the Reference 2 includes the two storage chambers having different shapes and each storage chamber includes thereon each flow hole. Consequently, the valve is required to have a shape corresponding to these flow holes. This leads to a complicated structure and a large-sized valve, which requires improvements.

A need thus exists for a fluid coupling device which is not susceptible to the drawback mentioned above.

### SUMMARY OF THE INVENTION

According to an aspect of the present invention, a fluid coupling device includes a driving rotor unitarily rotating with a drive shaft, a driven rotor supported by the drive shaft so as to rotate about the drive shaft and including an operation space accommodating therein the driving rotor, a valve unit supplying fluid stored in a storage space to the operation space via a supply passage in accordance with a change in air temperature in front of the driven rotor, and a pump portion provided on an outer periphery of the driving rotor for returning the fluid kept in a radial outward portion of the operation space to the storage space via a circulation passage by applying a pressure on the fluid, wherein a driving force of the driving rotor is transmitted to the driven rotor by viscosity of the fluid when the fluid is supplied by the valve unit from the storage space to the operation space via the supply passage. The valve unit includes a valve member and a temperature sensing portion. The valve member is movable between a closed position where an opening provided on a wall of the storage space for guiding the fluid stored in the storage space to the supply passage is closed and an open position where the opening is open. The valve member includes an intermediate flow passage for keeping a predetermined amount of the fluid in the storage space and supplying the rest of the fluid to the opening when the valve member is in a predetermined position located between the closed position and the open position, thereby circulating the fluid from the operation space to the storage space via the circulation passage. The temperature sensing portion keeps the valve member in the closed position when the air temperature in front of the driven rotor is less than a predetermined temperature and moves the valve member to the open position when the air temperature in front of the driven rotor is equal to or greater than the predetermined temperature.

According to another aspect of the present invention, the fluid coupling device includes a driving rotor unitarily rotating with a drive shaft, a driven rotor supported by the drive shaft via a bearing and including an operation space accommodating therein the driving rotor, a valve unit stopping supplying fluid stored in the storage space to the operation space when air temperature in front of the driven rotor is less than a predetermined temperature and supplying the fluid stored in a storage space to the operation space via a supply passage when the air temperature in front of the driven rotor is equal to or greater than a predetermined temperature, and a pump portion provided on an outer periphery of the driving rotor for returning the fluid stored in the operation space to the storage space via a circulation passage by allowing a pressure to act on the fluid, wherein a driving force of the driving rotor is transmitted to the driven rotor by viscosity of the fluid when the fluid is supplied by the valve unit from the storage space to the operation space via the supply passage, thereby returning the fluid by the pump portion from the operation space to the storage space via the circulation passage and the valve unit includes a valve member and a temperature sensing portion. The valve member is movable between a closed position where an opening provided on a wall of the storage space for guiding the fluid stored in the storage space to the supply passage is closed and an open position where the opening is open. The valve member includes an intermediate flow passage supplying an amount of the fluid stored in the storage space to the opening when the valve member is in a predetermined position located between the closed position and the open position. The amount of the fluid to be supplied to the opening when the valve member is in a predetermined position is less than an amount of the fluid supplied to the opening when the air temperature in front of the driven rotor is equal to or greater than the predetermined temperature. The temperature sensing portion keeps the valve member in the closed position when the air temperature in front of the driven rotor is less than the predetermined temperature and moves the valve member to the open position when the air temperature in front of the driven rotor is equal to or greater than the predetermined temperature.

### BRIEF DESCRIPTION OF THE DRAWINGS

The foregoing and additional features and characteristics of the present invention will become more apparent from the following detailed description considered with the reference to the accompanying drawings, wherein:

FIG. 1 is a cross-sectional view taken on line I-I of FIG. 2 for showing a fluid coupling device of a first embodiment;

FIG. 2 is a cross sectional view showing a relation between positions of a valve member and supply ports of the first embodiment;

FIG. 3 is a perspective view of the valve member of the first embodiment

FIG. 4 is a view showing a relation between the positions of the valve member and corresponding states of fluid of the first embodiment;

FIG. 5 is a graph showing a relation between air temperature and rotation speed of a fan of the first and second embodiments;

FIG. 6 is a cross sectional view of a fluid coupling device of a second embodiment; and

FIG. 7 is a cross sectional view showing a relation between the positions of the valve member and the corresponding states of the fluid of the second embodiment.

### DETAILED DESCRIPTION

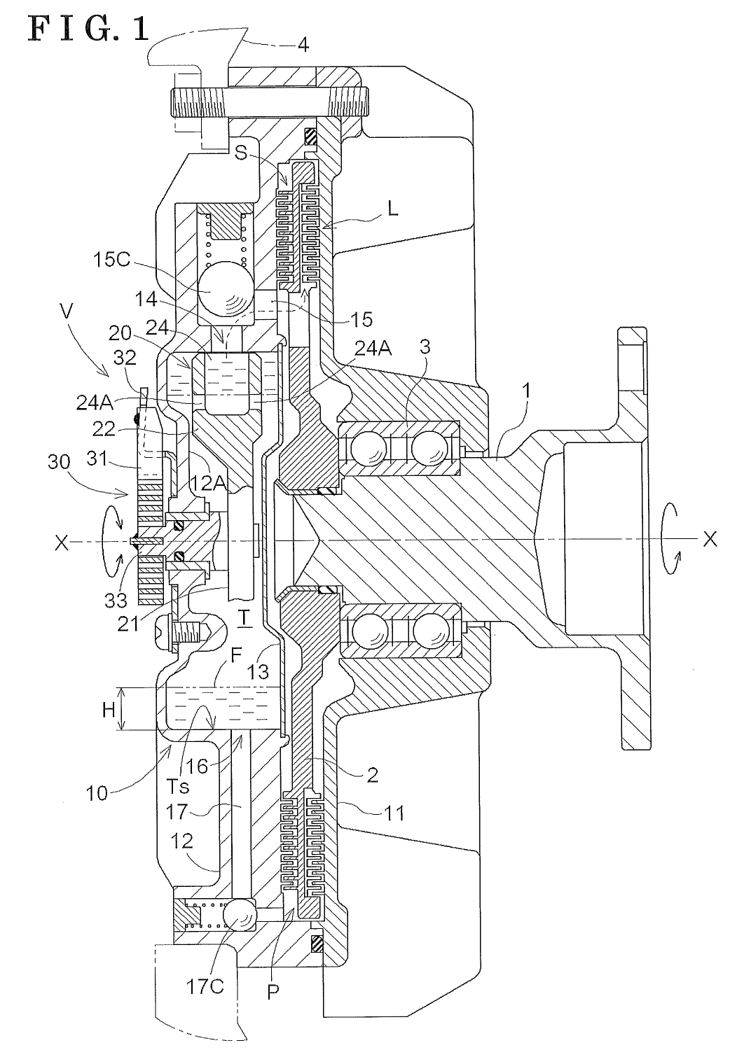

A first embodiment of the present invention will be explained with reference to the illustrations as follows. As shown in FIG. 1, a fluid coupling device includes a driving rotor 2, a driven rotor 10 and a valve unit V. The driving rotor 2 is disc-shaped and unitarily rotates with a drive shaft 1 that is rotated by a driving force of an engine. The driven rotor 10 is supported by the drive shaft 1 via a bearing 3 constituted by a ball bearing and rotates about the drive shaft 1. The driven rotor 10 includes an operation space S accommodating therein the driving rotor 2. The valve unit V is a temperature-sensitive type and controls supply of a fluid F stored in a storage space T to the operation space S of the driven rotor 10.

The fluid coupling device of this embodiment includes a fan 4 on an outer periphery of the driven rotor 10 and is located behind a radiator that is mounted on a front portion of a vehicle and cools engine coolant returned from the engine. In FIGS. 1, 6 and 7, the left side corresponds to the front side, and the right side corresponds to the rear side of the vehicle.

The fluid coupling device of this embodiment is provided with the valve unit V that operates in accordance with temperature of air sent to a front of the driven rotor 10, that is air temperature. The valve unit V stops the supply of the fluid F from the storage space T to the operation space S when the air temperature is low, that is, less than a predetermined temperature, thereby keeping the fan 4 stopped from rotating. The valve unit V supplies the fluid F from the storage space T to the operation space S when the air temperature rises to be equal to or greater than the predetermined temperature. Thus, a rotary force, that is a driving force, of the driving rotor 2 is transmitted to the driven rotor 10 utilizing viscosity of the fluid F, thereby driving the fan 4 to rotate. In this way, the fluid coupling device of this embodiment functions as a coupling device.

The fluid T stored in the storage space T is supplied to the operation space S via a supply passage 15. In a pump portion P provided in an outer periphery of the driving rotor 2, a pressure, that is, a centrifugal force of rotation of the driving member 2, is generated and acts on the fluid F, and thus the fluid F is returned to the storage space T via a return passage 17. Thus, a circulatory effect takes place, where the fluid F is sent from the storage space T to the operation space S, then sent back to the storage space T again. A structure and an operation of the fluid coupling device for achieving the above description will be explained hereunder.

The driven rotor 10 includes a rear case 11, a front case 12 and the operation space S. The rear case 11 is supported by the drive shaft 1 so as to rotate coaxially with a rotation axis X of the drive shaft 1, and the front case 12 is connected to a front portion of the rear case 11. The operation space S accommodating therein the driving rotor 2 is provided between the rear case 11 and the front case 12.

In a radial outward portion of the driving rotor 2, a number of continuous annular protrusions and grooves are formed in a circumferential direction about the rotation axis X. Also in radial outward portions of the rear case 11 and the front case 12, a number of continuous annular protrusions and grooves are formed respectively so as to face the continuous annular protrusions and grooves formed in the radial outward portion of the driving rotor 2. A labyrinth portion L is constituted by these protrusions and grooves.

A dividing wall 13 is provided inside the front case 12 to form the storage space T for storing therein the fluid F. The storage space T is positioned in a radially central region of the front case 12. The fluid F, a relatively highly viscous fluid such as silicone oil, is stored in the storage space T.

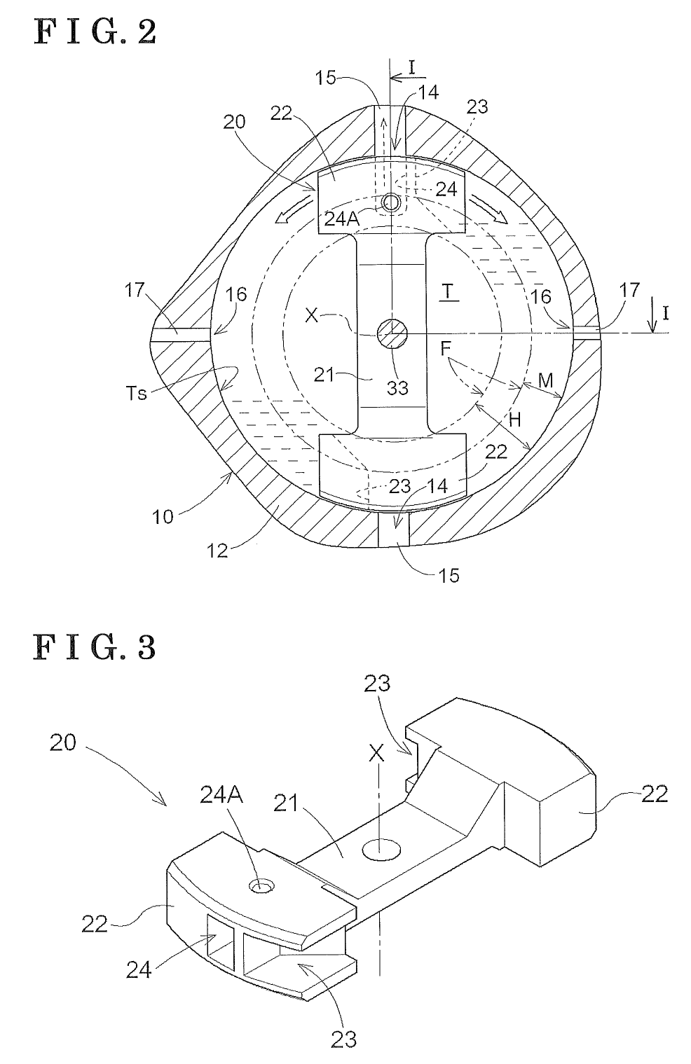

As shown in FIGS. 1 and 2, the storage space T includes an inner wall Ts serving as a wall provided in a circumferential direction about the rotation axis X to be in a cylindrical shape. On the inner wall Ts, a supply port 14 via which the fluid F is supplied to the supply passage 15 and a return port 16 via which the fluid F is returned from the operation space S are provided.

In this embodiment, the supply ports 14, 14 are provided in two positions facing each other across the rotation axis X. The return ports 16, 16 are provided in two positions facing each other across the rotation axis so as to be apart from the supply ports 14, 14 by 90 degrees when viewed in a direction along the rotation axis X.

The driven rotor 10 includes the supply passage 15 via which the fluid F is supplied from the supply port 14 to a radial inward portion, that is a portion closer to the rotation axis X, of the labyrinth portion L of the operation space S, and the return passage 17 via which the fluid F is returned from a radial outward portion, that is a portion farther from the rotation axis X, of the labyrinth portion L of the operation space S.

Provided on the supply passage 15 is a one-way valve 15C having a ball that opens the one-way valve 15C when pressure of the fluid F acts on the ball. Provided on the supply passage 17 is a one-way valve 17C having a ball that opens the one-way valve 17C when pressure of the fluid F acts on the ball.

The driven rotor 2 includes on the outer periphery thereof the pump portion P having a number of helical ridges. In the pump portion P, pressure for feeding the fluid F to the return passage 17 is generated by rotation of the driving rotor 2.

As shown in FIGS. 1 to 3, the valve unit V includes a valve member 20 changing its position anywhere between an open position where the supply port 14 serving as an opening is open and a closed position where the supply port 14 is closed. The valve unit V also includes a temperature sensing portion 30 for keeping the valve member 20 in the closed position when the air temperature in front of the driven rotor 10 is low, that is, less than the predetermined temperature, and moving the valve member 20 to the open position as the air temperature rises to be equal to or greater than the predetermined temperature.

The temperature sensing portion 30 includes a bimetal 31 having a coiled shape, a bracket 32 connected to a front wall 12A of the front case 12 and supporting an outer peripheral portion of the bimetal 31, and a rotation shaft 33 connected to a central end of the coil of the bimetal 31. The rotation shaft 33 is provided coaxially with the rotation axis X so as to penetrate the front wall 12A of the front case 12 in a front-rear direction when viewed in FIG. 1. Due to the above-described structure, the temperature sensing portion 30 causes the rotation shaft 33 to rotate by an amount corresponding to the air temperature that affects the bimetal 31.

The valve member 20 is connected to the rotation shaft 33, and includes an arm body 21 extending in a radial direction of the driven rotor 10 and valve bodies 22, 22 each provided on each pivot end of the arm body 21. The arm body 21 and the valve bodies 22, 22 are arranged so that the valve bodies 22, 22 are radially symmetrical with each other relative to the rotation axis X, thereby maintaining a rotation balance of the valve member 20.

A radially outer end of each valve body 22 is in a circular arc shape when viewed in the direction along the rotation axis X so as to fit the inner wall Ts of the storage space T. A portion of each valve body 22, which faces the supply port 14 when the valve member 20 is in the closed position, is formed to include a smooth surface so as to close the supply port 14. The radially outer end of each valve body 22 is provided with a recess 23 having a sufficiently larger cross sectional area than an opening area of the supply port 14 so that the supply port 14 is opened to the storage space T when the valve member 20 is in the open position.

On either one of a pair of valve bodies 22, 22, a through hole 24 is provided to serve as an intermediate flow passage 24 via which the fluid F stored in the storage space T is guided to the supply port 14 when the valve member 20 is in an intermediate position located between the open position and the closed position, that is a predetermined position. The through hole 24 is provided so that a bent channel is formed from the inner wall Ts of the storage space T to inlet ports 24A, 24A provided on walls of the valve body 22. The walls, on which the inlet ports 24A, 24A are formed, refer to the walls each perpendicular to the rotation axis X, that is, the wall facing the front and the wall facing the rear in FIG. 1.

The inlet port 24A is positioned radially inwardly apart from the inner wall Ts of the storage space T by a predetermined distance M and is formed to have a cross sectional area that is smaller than the opening area of the supply port 14.

The valve unit V is structured to keep the valve bodies 22, 22 in the closed position when the temperature of the air contacting the bimetal 31 is less than the predetermined temperature and causes the valve bodies 22, 22 to move, or causes the valve member 20 to pivot, in an open direction when the air temperature is equal to or greater than the predetermined temperature. Further, when the temperature of the air contacting the bimetal 31 reaches a predetermined high temperature, the temperature sensing portion 30 causes the valve bodies 22, 22 to move to the open position and keeps the valve bodies 22, 22 in the open position.

According to the fluid coupling device of this embodiment, almost all the amount of the fluid F is stored in the storage space T when the valve bodies 22, 22 are in the closed position, that is, the valve member 20 is in the closed position, because the fluid F is returned to the storage space T via the return passage 17 by a function of the pump portion P. At this time, a distance between a surface level of the fluid F and the inner wall Ts refers to a distance H as shown in FIG. 2.

When the valve bodies 22, 22 reach the intermediate position, the fluid F is supplied from the storage space T to the operation space S by sequentially passing the inlet ports 24A, 24A, the through hole 24, the supply port 14 and the supply passage 15. In this state, however, the surface level of the fluid F does not come closer to the inner wall Ts beyond the predetermined distance M, thus the predetermined amount of the fluid F remains in the storage space T as shown in FIG. 2.

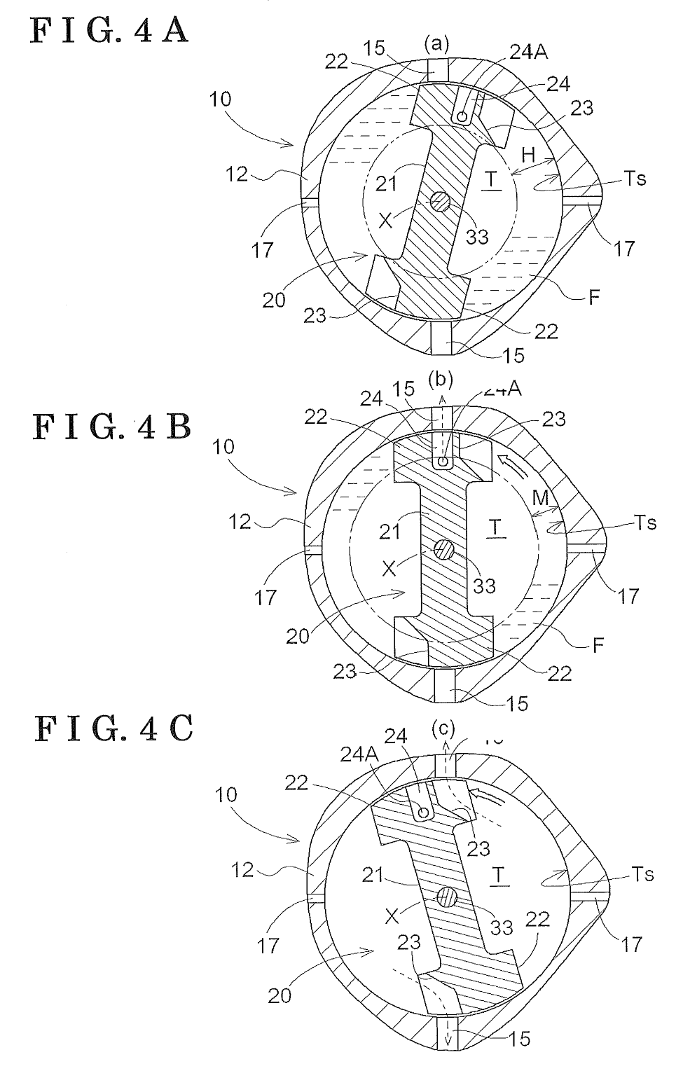

Due to the above-described structure, when the temperature of the air passing through the radiator is less than the predetermined temperature (low temperature), for example, immediately after the engine starts, the valve bodies 22, 22 are kept in the closed position as shown in FIG. 4A by a function of the temperature sensing portion 30, and thus the fluid F stored in the storage space T is not supplied to the labyrinth portion L. Consequently, the driving rotor 2 rotates but the rotary force of the driving rotor 2 is not transmitted to the driven rotor 10, and thus the fan 4 is not rotated (a first state).

In case the fluid F remains in the operation space S when the engine starts, the rotary force of the driving rotor 2 is transmitted to the driven rotor 10 by a function of the viscosity of the fluid F in the labyrinth portion L for a short period of time immediately after the engine start-up. However, the fluid F remaining in the operation space S is moved to the radial outward portion of the operation space S by the centrifugal force and then returned to the storage space T via the return passage 17 by the function of the pump portion P, thereby stopping the rotation of the driven rotor 10 immediately.

When the temperature of the air passing through the radiator rises as temperature of the engine rises, the bimetal 31 is deformed and thus the rotation shaft 33 is rotated. As the rotation shaft 33 is rotated, the valve bodies 22, 22 are moved in the open direction and reach the intermediate position as shown in FIG. 4B.

When the valve bodies 22, 22 are in the intermediate position, the fluid F is supplied from the storage space T to the operation space S by sequentially passing one of the inlet ports 24A, 24A, the through hole 24, the supply port 14 and the supply passage 15, thereby eventually reaching the labyrinth portion L. At the same time, the fluid F that reached the labyrinth portion L is moved to the radial outward portion of the labyrinth portion L by the centrifugal force acting on the fluid F, and then returned to the storage space T via the return passage 17 by the function of the pump portion P.

In this state, as described before, the predetermined amount of the fluid F remains in the storage space T and the distance between the surface level of the fluid F and the inner wall Ts does not exceed the predetermined distance M. That is, only a fixed amount of the fluid F is supplied to the operation storage S and an insufficient transmission of the rotary force takes place in the labyrinth portion L because the transmission of the rotary force due to the viscosity of the fluid F is insufficient. As a result, the driven rotor 10 and the fan 4 are rotated at a lower speed than a rotation speed of the driving rotor 2 in a similar manner to that of a so-called half clutch state (a second state).

After this, when the temperature of the air passing through the radiator further rises to reach the predetermined high temperature as the temperature of the engine further rises, the bimetal 31 is further deformed. As a result, the rotation shaft 33 is rotated and the valve bodies 22, 22 reach the open position as shown in FIG. 4C.

When the valve bodies 22, 22 are in the open position, the fluid F is supplied from the storage space T to the operation space S by sequentially passing the recess 23 of the valve body 22, the supply port 14 and the supply passage 15, thereby eventually reaching the labyrinth portion L. In this state, all the amount of the fluid F stored in the storage space T is supplied to the labyrinth portion L, and then the fluid F is returned to the storage space T via the return passage 17 by the function of the pump portion P.

In this state, all the amount of the fluid F stored in the storage space T is supplied to the operation space S and a full transmission of the rotary force takes place in the labyrinth portion L by the function of the viscosity of the fluid F. As a result, the driving rotor 2 and the driven rotor 10 are unitarily rotated, and thus the fan 4 is also rotated at a high speed (a third state).

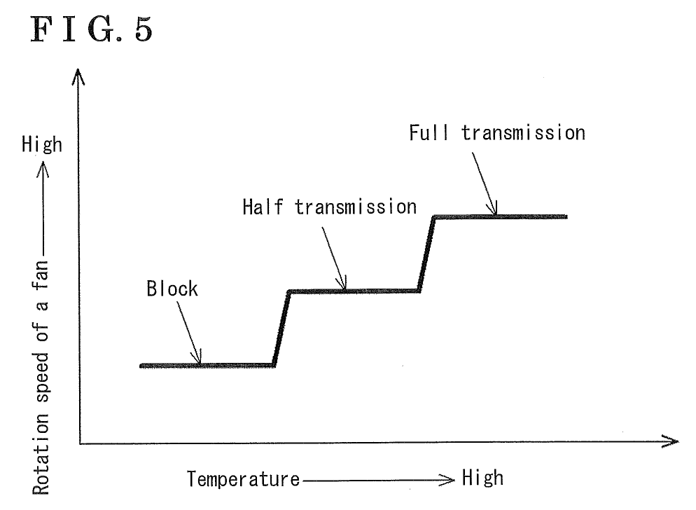

In FIG. 5, a state where the rotary force is not transmitted from the driving rotor 2 to the driven rotor 10 is referred to as a state of “block”, a state where the rotary force is fully transmitted is referred to as a state of “full transmission”, and a state where the rotary force is insufficiently transmitted is referred to as a state of “half transmission” (the so-called half clutch state). As shown in FIG. 5, the “half transmission state” appears in a certain temperature range lower than the predetermined high temperature at which the state of “full transmission” is achieved.

In the first embodiment, both the one-way clutch 15C provided on the supply passage 15 and the one-way clutch 17C provided on the supply passage 17 are not necessary. Either one of the one-way clutch 15C and the one-way clutch 17C may be provided. Alternatively, neither the one-way clutch 15C nor the one-way clutch 17C may be provided.

The fluid coupling device may be structured as described in a second embodiment hereunder. In the second embodiment, a basic structure of the fluid coupling is the same as that in the first embodiment, except for a structure of the valve unit V. In the second embodiment, the same reference numerals as in the first embodiment designate the same or corresponding parts or functions.

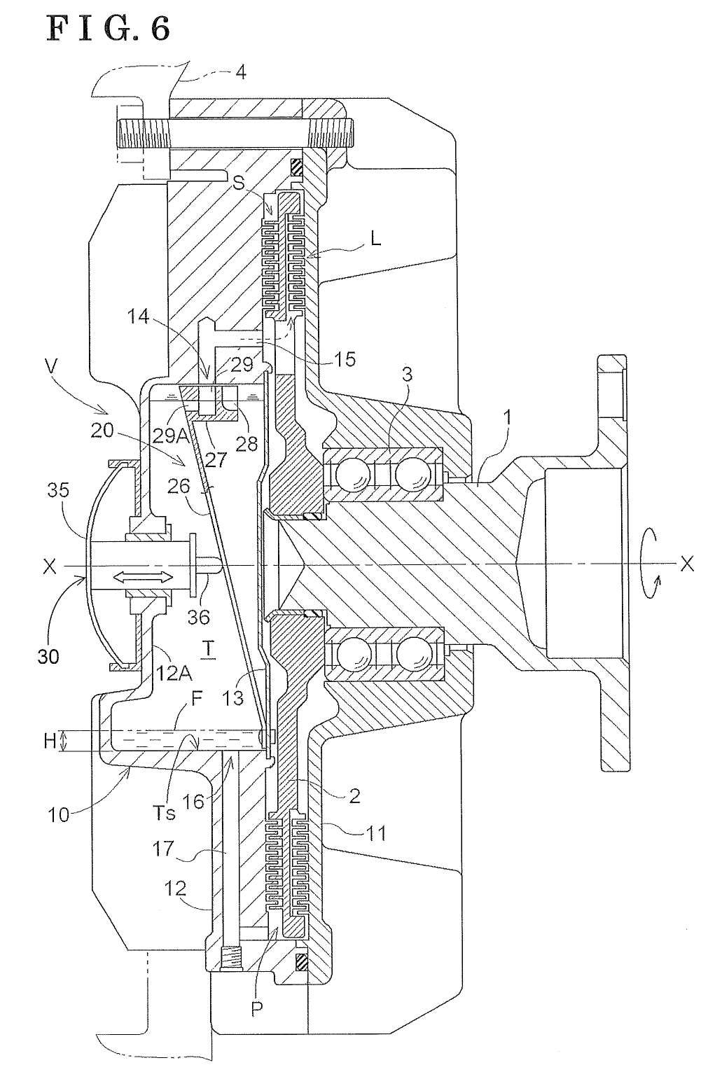

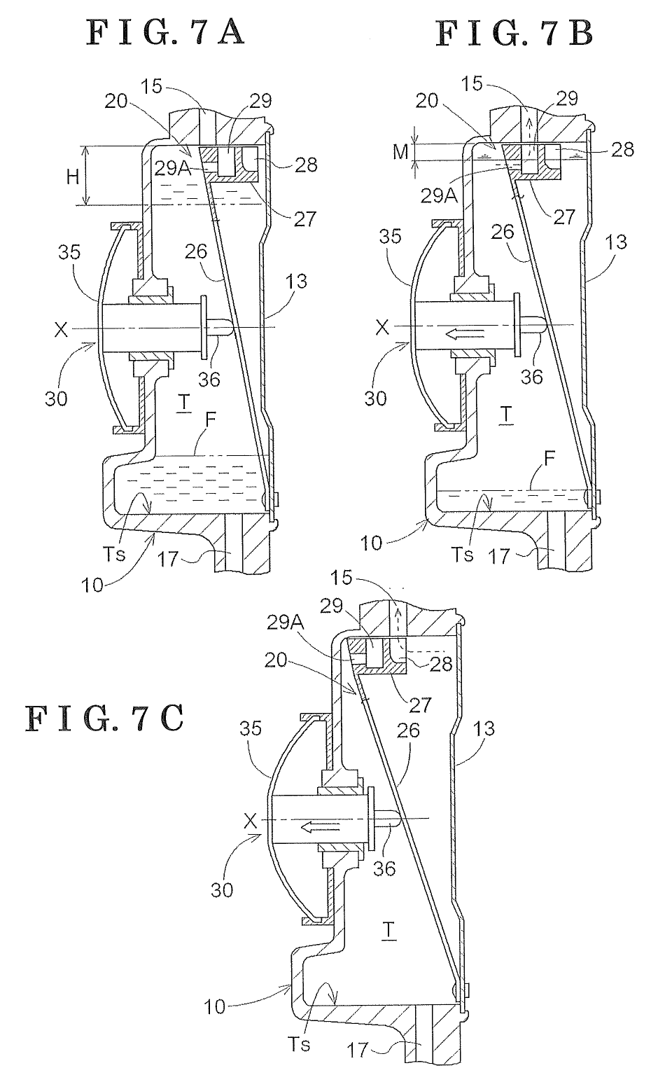

As shown in FIGS. 6 and 7, the valve unit V includes the valve member 20 and the temperature sensing portion 30. The valve member 20 linearly changes its position anywhere between the open position where the supply port 14 serving as the opening is open and the closed position where the supply port 14 is closed. The temperature sensing portion 30 causes the valve member 20 to move in the open direction as the air temperature rises.

The valve member 20 includes a flat spring 26 serving as a supporting member, and a valve block 27. One end of the flat spring 26 is fixedly attached to the dividing wall 13 of the storage space T with a rivet and the other end of the flat spring 26 supports the valve block 27. The temperature sensing portion 30 includes a bimetal 35 of a curved shape, and a push rod 36 provided in a position on which a pressing force from the bimetal 35 acts.

The bimetal 35 is deformed as the air temperature rises, so that a central portion of the bimetal 35 moves away from the front wall 12A of the front case 12. As shown in FIG. 6, the push rod 36 is provided coaxially with the rotation axis X so as to penetrate the front wall 12A in the front-rear direction.

A portion of the valve block 27, which faces the supply port 14 when the valve block 27 is in the closed position, is formed to include the smooth surface so as to close the supply port 14. The portion of the valve block 27 is also provided with a recess 28 having a sufficiently larger cross sectional area than the opening area of the supply port 14 so that the supply port 14 is opened to the storage space T when the valve block 27 is in the open position. On the valve block 27, a through hole 29 is provided to serve as the intermediate flow passage 29 via which the fluid F stored in the storage space T is guided to the supply port 14 when the valve block 27 is in the intermediate position located between the open position and the closed position, that is the predetermined position. The through hole 29 is provided so that the bent channel is formed from the inner wall Ts of the storage space T to an inlet port 29A provided on a wall of the valve block 27. The wall, on which the inlet port 29A is formed, refers to the wall facing the front in FIG. 6.

The inlet port 29A is positioned radially inwardly apart from the inner wall Ts of the storage space T by the predetermined distance M and is structured to have a cross sectional area that is smaller than the opening area of the supply port 14.

The flat spring 26 is given a biasing force in a direction that the flat spring 26 comes in contact with the push rod 36. When the air temperature is low, the push rod 36 is pushed by the bimetal 35 farthest in a direction of the flat spring 26, that is, in the rear direction, and thus the valve block 27 is kept in the closed position. As the air temperature rises, the push rod 36 moves forward and the pressing force acting on the flat spring 26 decreases, and thus the valve block 27 is moved to the intermediate position or the open position by the biasing force of the flat spring 26.

The valve unit V is structured to keep the valve block 27, that is, the valve member 20, in the closed position when the temperature of the air contacting the bimetal 35 is less than the predetermined temperature and causes the valve block 27 to move, or shift, in the open direction when the air temperature is equal to or greater than the predetermined temperature. Further, when the temperature of the air contacting the bimetal 35 reaches the predetermined high temperature, the temperature sensing portion 30 causes the valve block 27 to move to the open position and keeps the valve block 27 in the open position.

Due to the above-described structure, when the temperature of the air passing through the radiator is less than the predetermined temperature (low temperature), for example, immediately after the engine starts, the valve block 27 is kept in the closed position as shown in FIG. 7A by the function of the temperature sensing portion 30, and thus the fluid F stored in the storage space T is not supplied to the labyrinth portion L. Consequently, the driving rotor 2 rotates but the rotary force of the driving rotor 2 is not transmitted to the driven rotor 10, and thus the fan 4 is not rotated (the first state).

In the meantime, the fluid F is returned to the storage space T via the return passage 17 by the function of the pump portion P, and thus almost all the amount of the fluid F is stored in the storage space T. At this time, the distance between the surface level of the fluid F and the inner wall Ts refers to the distance H.

When the temperature of the air passing through the radiator rises as the temperature of the engine rises, the bimetal 35 is deformed and thus the push rod 36 is moved forward. As the push rod 36 is moved forward, the valve block 27 is moved in the open direction and reaches the intermediate position as shown in FIG. 7B.

When the valve block 27 is in the intermediate position, the fluid F is supplied from the storage space T to the operation space S by sequentially passing the inlet port 29A, the through hole 29, the supply port 14 and the supply passage 15, thereby eventually reaching the labyrinth portion L. At the same time, the fluid F that reached the labyrinth portion L is moved to the radial outward portion of the labyrinth portion L by the centrifugal force acting on the fluid F, and then returned to the storage space T via the return passage 17 by the function of the pump portion P.

In this state, the surface level of the fluid F does not come closer to the inner wall Ts beyond the predetermined distance M, thus the predetermined amount of the fluid F remains in the storage space T as shown in FIG. 2. That is, only the fixed amount of the fluid F is supplied to the operation storage S and the insufficient transmission of the rotary force takes place in the labyrinth portion L because the transmission of the rotary force due to the viscosity of the fluid F is insufficient. As a result, the driven rotor 10 and the fan 4 are rotated at the lower speed than the rotation speed of the driving rotor 2 in the similar manner to that of the half clutch state (the second state).

After this, when the temperature of the air passing through the radiator further rises as the temperature of the engine further rises, the bimetal 35 is further deformed. As a result, the push rod 36 is moved forward and the valve block 27 reaches the open position as shown in FIG. 7C.

When the valve block 27 is in the open position, the fluid F is supplied from the storage space T to the operation space S by sequentially passing the recess 28 of the valve block 27, the supply port 14 and the supply passage 15, thereby eventually reaching the labyrinth portion L. In this state, all the amount of the fluid F stored in the storage space T is supplied to the labyrinth portion L, and then the fluid F is returned to the storage space T via the return passage 17 by the function of the pump portion P.

In this state, all the amount of the fluid F stored in the storage space T is supplied to the operation space S and the full transmission of the rotary force takes place in the labyrinth portion L by the function of the viscosity of the fluid F. As a result, the driving rotor 2 and the driven rotor 10 are unitarily rotated, and thus the fan 4 is also rotated at the high speed (the third state).

Similarly to the first embodiment, a relation between the air temperature and a rotation speed of the fan 4 of the second embodiment is shown in FIG. 5.

Due to the above-described structure, when temperature of the engine coolant is low, for example, immediately after the engine starts, the fan 4 is not rotated, thereby avoiding overcooling of the engine. When the temperature of the engine coolant slightly increases as the engine warms up, the fan 4 is rotated at a low speed, that is, the second state between the first state where the fan 4 is not rotated and the third state where the fan is rotated at the high speed is established, and thus the engine is appropriately cooled. After the temperature of the engine coolant sufficiently rises, the fan 4 is rotated at the maximum speed, and thus the engine is sufficiently cooled.

In particular, when the valve bodies 22, 22 (the valve block 27) reach the intermediate position, the fan 4 is rotated at the low speed because the fixed amount of fluid F is supplied to the operation storage S and a portion of the fluid F, that is, the predetermined amount of the fluid F, remains in the storage space T. This allows the rotation speed of the fan 4 to be adjusted by changing the position of the inlet ports 24A, 24A (29A).

As described above, the valve member 20 of the valve unit V establishes the three states; the first state where the fluid F stored in the storage space T is not supplied to the operation space S, the second state where the fixed amount of the fluid F is supplied to the operation space S and the predetermined amount of the fluid F remains in the storage space T, and the third state where all the amount of the fluid F stored in the storage space T is supplied to the operation space S. In addition to the first and third states where the rotary force is not transmitted or fully transmitted respectively, the second state is established where the driven rotor 10 is rotated at the lower speed than when the driving rotor 2 and the driven rotor 10 are unitarily rotated. As a result, the engine is appropriately cooled.

Due to the above-described structure, when the valve member 20 is in the intermediate position, in the course of moving from the closed position to the open position as the air temperature rises, the fluid F stored in the storage space T is supplied to the supply port 14 via the through hole 24 provided on the valve member 20. When the valve member 20 is in the intermediate position, the predetermined amount of the fluid F remains in the storage space F, and thus less amount of the fluid F is supplied to the operation space S than when the valve member 20 is in the opened position. As a result, the rotary force of the driving rotor 2 is insufficiently transmitted to the driven rotor 10, and thus the rotation speed of the driven rotor 10 is lower than the rotation speed of the driving rotor 2. Thus, the fluid coupling device of the first and second embodiments provides the state where the rotary force is transmitted but the driven rotor 10 is rotated at the lower speed (the second state) compared to the state where the rotary force is fully transmitted (the third state).

According to the first embodiment, the wall Ts of the storage space T is in the cylindrical shape and the center of the cylindrical shape corresponds to the rotation axis X of the driven rotor 10. The valve member 20 includes the arm body 21 pivoting about the rotation axis X and the valve body 22 provided on the pivot end of the arm body 21. The intermediate flow passage 24 is constituted by the through hole 24 provided on the valve body 22.

According to the first embodiment, the wall Ts of the storage space T is in the cylindrical shape and the center of the cylindrical shape corresponds to the rotation axis X of the driven rotor 10. The valve member 20 includes the arm body 21 pivoting about the rotation axis X and the valve body 22 provided on the pivot end of the arm body 21. The intermediate flow passage 24 is constituted by the through hole 24 formed on one surface of the valve body 22 to extend in a direction of another surface of the valve body 22, where the one surface is spaced radially and inwardly from the wall Ts, and the another surface faces the wall Ts.

Due to the above-described structure, when the valve bodies 22, 22 are in the position located between the closed position and the open position, the fluid F is supplied to the operation space S via the through hole 24 provided on the pivot ends of the arm body 21. Since the through hole 24 allows the fluid F positioned radially inwardly apart from the inner wall T to be supplied to the supply passage 14, the amount of the fluid F remaining in the storage space T corresponds to the distance between the inlet ports 24A, 24A and the inner wall Ts. Consequently, an insufficient amount of the fluid F is supplied to the operation space S, and thus the rotation speed of the driven rotor 10 is maintained to be low.

According to the second embodiment, the wall Ts of the storage space T is in the cylindrical shape and the center of the cylindrical shape corresponds to the rotation axis X of the driven rotor 10. The valve member 20 includes the supporting member 26, one end of the supporting member 26 being fixedly attached to the dividing wall 13 of the storage space T. The valve member 20 includes the valve block 27 supported by another end of the supporting member 26. The intermediate flow passage 24 is constituted by the through hole 29 provided on the valve block 27.

According to the first embodiment, the valve body 22 includes the recess 23 provided in a radially outward direction of the driven rotor 10 and having the cross sectional area that is larger than the opening area of the opening 14 for supplying the fluid F stored in the storage space T to the opening 14 via the recess 23 when the valve member 20 is in the open position.

According to the second embodiment, the valve block 27 includes the recess 28 provided in the radially outward direction of the driven rotor 10 and having the cross sectional area that is larger than the opening area of the opening 14 for supplying the fluid F stored in the storage space T to the opening 14 via the recess 28 when the valve member 20 is in the open position.

According to the first embodiment, the temperature sensing portion 30 includes the bimetal 31 provided on an external surface, which is perpendicular to the rotation axis X, of the driven rotor 10 and generating the rotary force in response to the change in the air temperature, and the rotation shaft 33 rotated coaxially with the rotation axis X of the driven rotor 10 by the rotary force generated by the bimetal 31. The rotation shaft 33 is connected to the arm body 21.

Due to the above-described structure, temperature of the external surface of the driven rotor 10, which is perpendicular to the rotation axis X, is reflected to a pivotal position of the arm body 21, and thus a supply amount of the fluid F is regulated. That is, as the temperature of the external surface of the driven rotor 10 changes, the bimetal 31 is deformed and thus the rotation shaft 33 is rotated. As a result, the pivotal position of the arm body 21 is changed.

According to the second embodiment, the temperature sensing portion 30 includes the bimetal 35 provided on the external surface, which is perpendicular to the rotation axis X, of the driven rotor 10 and deformed in a direction of the rotation axis X of the driven rotor 10 in response to the change in the air temperature, and the push rod 36 moved in the direction of the rotation axis X by deformation of the bimetal 35, thereby pushing the supporting member 26.

According to the second embodiment, the wall Ts of the storage space T is formed in parallel with the rotation axis X of the driven rotor 10, the valve member 20 includes the valve block 27 supported by the supporting member 26 so as to slide on the wall Ts along the direction of the rotation axis X, and the intermediate flow passage 29 is constituted by the through hole 29 formed on one surface of the valve block 27 to extend in a direction of another surface of the valve block 27, where the one surface is spaced radially and inwardly from the wall Ts, and the another surface faces the wall Ts.

Due to the above-described structure, when the valve block 27 is in the intermediate position, the fluid F stored in the storage space T is supplied to the operation space S via the through hole 29 provided on the valve block 27 that is supported by the supporting member 26. Since the through hole 29 allows the fluid F positioned radially inwardly apart from the inner wall T to be supplied to the supply passage 15, the amount of the fluid F remaining in the storage space T corresponds to the distance between the inlet port 29A and the inner wall Ts. Consequently, the insufficient amount of the fluid F is supplied to the operation space S, and thus the rotation speed of the driven rotor 10 is maintained to be low.

According to the second embodiment, the supporting member 26 includes the flat spring 26 whose one end is connected to an inside portion of the storage space T and whose another end is connected to the valve block 27, and the temperature sensing portion 30 includes the bimetal 35 provided on the external surface, which is perpendicular to the rotation axis X, of the driven rotor 10 and changing the pressing force applied to an intermediate portion of the flat spring 26 in response to the change in the air temperature.

Due to the above-described structure, a temperature of the external surface of the driven rotor 10, which is perpendicular to the rotation axis X, is reflected to a position of the flat spring 26 and therefore to a position of the valve block 27, and thus the supply amount of the fluid F is regulated. That is, as the temperature of the external surface of the driven rotor 10 changes, the bimetal 35 is deformed and thus the push rod 36 is moved. As a result, the flat sparing 26 is shifted, thereby changing the position of the valve block 27.

The principles, preferred embodiments and modes of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A fluid coupling device, comprising:
a driving rotor unitarily rotating with a drive shaft;
a driven rotor supported by the drive shaft so as to rotate about the drive shaft and including an operation space accommodating therein the driving rotor;
a valve unit supplying fluid stored in a storage space to the operation space via a supply passage in accordance with a change in air temperature in front of the driven rotor; and
a pump portion provided on an outer periphery of the driving rotor for returning the fluid kept in a radial outward portion of the operation space to the storage space via a circulation passage by applying a pressure on the fluid, wherein
a driving force of the driving rotor is transmitted to the driven rotor by viscosity of the fluid when the fluid is supplied by the valve unit from the storage space to the operation space via the supply passage, and
the valve unit includes a valve member and a temperature sensing portion, the valve member being movable between a closed position where an opening provided on a wall of the storage space for guiding the fluid stored in the storage space to the supply passage is closed and an open position where the opening is open, the valve member including an intermediate flow passage for keeping a predetermined amount of the fluid in the storage space and supplying the rest of the fluid to the opening when the valve member is in a predetermined position located between the closed position and the open position, thereby circulating the fluid from the operation space to the storage space via the circulation passage, the temperature sensing portion keeping the valve member in the closed position when the air temperature in front of the driven rotor is less than a predetermined temperature and moving the valve member to the open position when the air temperature in front of the driven rotor is equal to or greater than the predetermined temperature.

2. A fluid coupling device, comprising:
a driving rotor unitarily rotating with a drive shaft;
a driven rotor supported by the drive shaft via a bearing and including an operation space accommodating therein the driving rotor;
a valve unit stopping supplying fluid stored in the storage space to the operation space when air temperature in front of the driven rotor is less than a predetermined temperature and supplying the fluid stored in a storage space to the operation space via a supply passage when the air temperature in front of the driven rotor is equal to or greater than a predetermined temperature; and
a pump portion provided on an outer periphery of the driving rotor for returning the fluid stored in the operation space to the storage space via a circulation passage by allowing a pressure to act on the fluid, wherein
a driving force of the driving rotor is transmitted to the driven rotor by viscosity of the fluid when the fluid is supplied by the valve unit from the storage space to the operation space via the supply passage, thereby returning the fluid by the pump portion from the operation space to the storage space via the circulation passage and
the valve unit includes a valve member and a temperature sensing portion, the valve member being movable between a closed position where an opening provided on a wall of the storage space for guiding the fluid stored in the storage space to the supply passage is closed and an open position where the opening is open, the valve member including an intermediate flow passage supplying an amount of the fluid stored in the storage space to the opening when the valve member is in a predetermined position located between the closed position and the open position, the amount of the fluid to be supplied to the opening when the valve member is in a predetermined position being less than an amount of the fluid supplied to the opening when the air temperature in front of the driven rotor is equal to or greater than the predetermined temperature, the temperature sensing portion keeping the valve member in the closed position when the air temperature in front of the driven rotor is less than the predetermined temperature and moving the valve member to the open position when the air temperature in front of the driven rotor is equal to or greater than the predetermined temperature.

3. The fluid coupling device according to claim 1, wherein the wall of the storage space is in a cylindrical shape and a center of the cylindrical shape corresponds to a rotation axis of the driven rotor, the valve member includes an arm body pivoting about the rotation axis and a valve body provided on a pivot end of the arm body, and the intermediate flow passage is constituted by a through hole provided on the valve body.

4. The fluid coupling device according to claim 2, wherein the wall of the storage space is in a cylindrical shape and a center of the cylindrical shape corresponds to a rotation axis of the driven rotor, the valve member includes an arm body pivoting about the rotation axis and a valve body provided on a pivot end of the arm body, and the intermediate flow passage is constituted by a through hole provided on the valve body.

5. The fluid coupling device according to claim 1, wherein the wall of the storage space is in a cylindrical shape and a center of the cylindrical shape corresponds to a rotation axis of the driven rotor, the valve member includes an arm body pivoting about the rotation axis and a valve body provided on a pivot end of the arm body, and the intermediate flow passage is constituted by a through hole formed on one surface of the valve body to extend in a direction of another surface of the valve body, the one surface facing the wall, and the another surface spaced radially and inwardly from the wall.

6. The fluid coupling device according to claim 2, wherein the wall of the storage space is in a cylindrical shape and a center of the cylindrical shape corresponds to a rotation axis of the driven rotor, the valve member includes an arm body pivoting about the rotation axis and a valve body provided on a pivot end of the arm body, and the intermediate flow passage is constituted by a through hole formed on one surface of the valve body to extend in a direction of another surface of the valve body, the one surface facing the wall, and the another surface spaced radially and inwardly from the wall.

7. The fluid coupling device according to claim 1, wherein the wall of the storage space is in a cylindrical shape and a center of the cylindrical shape corresponds to a rotation axis of the driven rotor, the valve member includes a supporting member, one end of the supporting member being fixedly attached to a dividing wall of the storage space, and a valve block supported by another end of the supporting member, and
the intermediate flow passage is constituted by a through hole provided on the valve block.

8. The fluid coupling device according to claim 2, wherein the wall of the storage space is in a cylindrical shape and a center of the cylindrical shape corresponds to a rotation axis of the driven rotor, the valve member includes a supporting member, one end of the supporting member being fixedly attached to a dividing wall of the storage space, and a valve block supported by another end of the supporting member, and
the intermediate flow passage is constituted by a through hole provided on the valve block.

9. The fluid coupling device according to claim 3, wherein the valve body includes a recess provided in a radially outward direction of the driven rotor and having a cross sectional area that is larger than an opening area of the opening for supplying the fluid stored in the storage space to the opening via the recess when the valve member is in the open position.

10. The fluid coupling device according to claim 4, wherein the valve body includes a recess provided in a radially outward direction of the driven rotor and having a cross sectional area that is larger than an opening area of the opening for supplying the fluid stored in the storage space to the opening via the recess when the valve member is in the open position.

11. The fluid coupling device according to claim 7, wherein the valve block includes a recess provided in a radially outward direction of the driven rotor and having a cross sectional area that is larger than an opening area of the opening for supplying the fluid stored in the storage space to the opening via the recess when the valve member is in the open position.

12. The fluid coupling device according to claim 8, wherein the valve block includes a recess provided in a radially outward direction of the driven rotor and having a cross sectional area that is larger than an opening area of the opening for supplying the fluid stored in the storage space to the opening via the recess when the valve member is in the open position.

13. The fluid coupling device according to claim 5, wherein the temperature sensing portion includes a bimetal provided on an external surface of the driven rotor, the external surface being perpendicular to the rotation axis, and generating a rotary force in response to a change in the air temperature, and a rotation shaft rotated coaxially with the rotation axis of the driven rotor by the rotary force generated by the bimetal, the rotation shaft being connected to the arm body.

14. The fluid coupling device according to claim 6, wherein the temperature sensing portion includes a bimetal provided on an external surface of the driven rotor, the external surface being perpendicular to the rotation axis, and generating a rotary force in response to a change in the air temperature, and a rotation shaft rotated coaxially with the rotation axis of the driven rotor when rotated by the rotary force generated by the bimetal, the rotation shaft being connected to the arm body.

15. The fluid coupling device according to claim 7, wherein the temperature sensing portion includes a bimetal provided on an external surface of the driven rotor, the external surface being perpendicular to the rotation axis, and deformed in a direction of the rotation axis of the driven rotor in response to a change in the air temperature, and a push rod moved in the direction of the rotation axis by deformation of the bimetal, thereby pushing the supporting member.

16. The fluid coupling device according to claim 8, wherein the temperature sensing portion includes a bimetal provided on an external surface of the driven rotor, the external surface being perpendicular to the rotation axis, and deformed in a direction of the rotation axis of the driven rotor in response to a change in the air temperature, and a push rod moved in the direction of the rotation axis by deformation of the bimetal, thereby pushing the supporting member.

17. The fluid coupling device according to claim 1, wherein the wall of the storage space is formed in parallel with a rotation axis of the driven rotor, the valve member includes a valve block supported by a supporting member so as to slide on the wall along the direction of the rotation axis, and an intermediate flow passage is constituted by a through hole formed on one surface of the valve block to extend in a direction of another surface of the valve block, the one surface spaced radially and inwardly from the wall, and the another surface facing the wall.

18. The fluid coupling device according to claim 2, wherein the wall of the storage space is formed in parallel with a rotation axis of the driven rotor, the valve member includes a valve block supported by a supporting member so as to slide on the wall along the direction of the rotation axis, and an intermediate flow passage is constituted by a through hole formed on one surface of the valve block to extend in a direction of another surface of the valve block, the one surface spaced radially and inwardly from the wall, and the another surface facing the wall.

19. The fluid coupling device according to claim 17, wherein the supporting member includes a flat spring, one end of the flat spring connected to an inside portion of the storage space and another end connected to the valve block, and the temperature sensing portion includes a bimetal provided on an external surface of the driven rotor, the external surface being perpendicular to the rotation axis of the driven rotor, and changing a pressing force applied to an intermediate portion of the flat spring in response to a change in the air temperature.

20. The fluid coupling device according to claim 18, wherein the supporting member includes a flat spring, one end of the flat spring connected to an inside portion of the storage space and another end connected to the valve block, and the temperature sensing portion includes a bimetal provided on an external surface of the driven rotor, the external surface being perpendicular to the rotation axis of the driven rotor, and changing a pressing force applied to an intermediate portion of the flat spring in response to a change in the air temperature.
